(19) United States
(12) Patent Application Publication
(10) Pub. No.: US 2014/0115514 A1
(43) Pub. Date: Apr. 24, 2014

(54) USER-SPECIFIC MOBILE COMPUTING DEVICE RESOURCE MANAGEMENT

(71) Applicant: Google Inc., Mountain View, CA (US)

(72) Inventors: Dianne Kyra Hackborn, Menlo Park, CA (US); Amith Yamasani, San Jose, CA (US); Jeffrey Allen Sharkey, Mountain View, CA (US)

(21) Appl. No.: 13/933,884

(22) Filed: Jul. 2, 2013

Related U.S. Application Data
(60) Provisional application No. 61/716,452, filed on Oct. 19, 2012.
(60) Provisional application No. 61/791,244, filed on Mar. 15, 2013.

(51) Int. Cl. G06F 3/0481

(52) U.S. Cl. CPC G06F 3/0481
USPC 715/771

(57) ABSTRACT

A mobile computing device can detect, for at least two respective user profiles of a plurality of user profiles, use of the component associated with the respective user profile. The mobile computing device can also determine, for each of the at least two respective user profiles, resource consumption caused by the detected use of the component over a period of time. The mobile computing device can further generate, for at least one of the at least two respective user profiles, a visual representation comprising an indication of the resource consumption caused by the detected use of the component associated with one of the respective user profiles, an indication of the component associated with the resource consumption associated with the one of the respective user profiles, and an indication of the one of the respective user profiles.

This application claims the benefit of U.S. Provisional Application No. 61/716,452, filed Oct. 19, 2012, and U.S. Provisional Application No. 61/791,244, filed Mar. 15, 2013, the entire contents of each of which are incorporated herein by reference.

### BACKGROUND

Mobile computing devices, such as mobile phones and tablet computers, are becoming increasingly powerful and ubiquitous in use. Software applications for these computerized devices are becoming widely available and offer extensive and ever increasing functionality. As a result, mobile computing devices are capable of processing a wide variety and potentially sensitive or personal information (e.g., documents, e-mails, and pictures) for display (e.g., on a screen) or otherwise for output to a user.

Certain mobile computing devices can operate in a limited access state that prevents an unauthorized user from accessing applications and information stored within the computing device, thereby effectively “locking” the computing device. For example, some mobile computing devices require a user to provide a specific input to lock and/or unlock the device. While the locking techniques can provide security for information contained within the device as well as protection from accidental inputs, once the device is unlocked, the computing device provides access to the applications and information stored within the computing device to any user who provides the specific input to unlock the device.

Some mobile computing devices enable multiple user profiles. For example, a mobile computing device may be configured with multiple, different user profiles, each user profile being separate from the other user profiles such that a user associated with a first user profile is prevented from gaining access to another user's profile without providing proper authentication information for the other user profile. As an example, a first user profile may be associated with a first user's information and a first set of installed applications while a second user profile may be associated a second user's information and a second, potentially overlapping, set of applications.

### SUMMARY

In an example, a method includes detecting, by a mobile computing device, for at least two respective user profiles of a plurality of user profiles, use of a component of the mobile computing device associated with the respective user profile, wherein the component comprises at least one of a hardware or a software component of the mobile device, and wherein the mobile computing device is configured to operate, at a given time, based at least in part on one or more configuration settings associated with one user profile of the plurality of user profiles. According to this example, the method also includes determining, by the mobile computing device, for each of the at least two respective user profiles, resource consumption caused by the detected use of the component of the mobile computing device over a period of time, wherein the resource consumption comprises at least one of an amount of data transmissions and power consumption of a battery of the mobile computing device. The method also may include generating, by the mobile computing device, for at least one of the at least two respective user profiles, a visual representation comprising an indication of the resource consumption caused by the detected use of the component associated with one of the respective user profiles, an indication of the component associated with the resource consumption associated with the one of the respective user profiles, an indication of the one of the respective user profiles, and an indication of the period of time.

In another example, a mobile computing device is configured to operate, at a given time, based at least in part on one or more configuration settings associated with one user profile of a plurality of user profiles. The mobile computing device can include a component comprising at least one of a hardware or a software component or the mobile device, and at least one processor. The at least one processor may be configured to detect, for at least two respective user profiles of the plurality of user profiles, use of the component associated with the respective user profile. The at least one processor also may be configured to determine, for each of the at least two respective user profiles, resource consumption caused by the detected use of the component over a period of time, wherein the resource consumption comprises at least one of an amount of data transmissions and power consumption of a battery of the mobile computing device. Further, the at least one processor may be configured to generate, for at least one of the at least two respective user profiles, a visual representation comprising an indication of the resource consumption caused by the detected use of the component associated with one of the respective user profiles, an indication of the component associated with the resource consumption associated with the one of the respective user profiles, and an indication of the one of the respective user profiles.

In a further example, a computer-readable storage medium can be encoded with instructions that, when executed, cause at least one processor of a mobile computing device to detect, for at least two respective user profiles of a plurality of user profiles, use of a component of the mobile computing device associated with the respective user profile, wherein the component comprises at least one of a hardware or a software component of the mobile device, and wherein the mobile computing device is configured to operate, at a given time, based at least in part on one or more configuration settings associated with one user profile of the plurality of user profiles. The computer-readable storage medium also can be encoded with instructions that, when executed, cause the at least one processor of the mobile computing device to determine, for each of the at least two respective user profiles, resource consumption caused by the detected use of the component of the mobile computing device over a period of time, wherein the resource consumption comprises at least one of an amount of data transmissions and power consumption of a battery of the mobile computing device. Additionally, the computer-readable storage medium can be encoded with instructions that, when executed, cause the at least one processor of the mobile computing device to generate, for at least one of the at least two respective user profiles, a visual representation comprising an indication of the resource consumption caused by the detected use of the component associated with one of the respective user profiles, an indication of the component associated with the resource consumption associated with the one of the respective user profiles, an indication of the one of the respective user profiles, and an indication of the period of time.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example mobile computing device and example graphical user interfaces (GUIs) for user-specific resource usage on the mobile computing device.

FIG. 2 is a block diagram illustrating further details of an example of a computing device shown in FIG. 1.

FIG. 3 is a block diagram illustrating an example computing device that outputs graphical content for display at a remote device, in accordance with one or more techniques of the present disclosure.

FIG. 4 is a flowchart illustrating an example method according to this disclosure.

FIG. 5 is a flowchart illustrating another example method according to this disclosure.

FIG. 6 is a screenshot illustrating an example GUI generated and displayed as part of the example method of FIG. 5.

FIG. 7 is a flowchart illustrating another example method according to this disclosure.

FIG. 8 is a screenshot illustrating an example GUI generated and displayed as part of the example method of FIG. 7.

### DETAILED DESCRIPTION

In general, this disclosure describes techniques for enabling and supporting multiple user profiles on a mobile computing device. In some instances, a mobile computing device may be configured with multiple, different user profiles, each user profile being separate from the other user profiles such that a user associated with a first user profile is prevented from gaining access to other users' profiles without providing proper authentication information for the other user profiles. As an example, a first user profile may be associated with a user's personal information and a first set of installed applications while a second user profile may be associated a user's work information and a second, potentially overlapping, set of applications. By providing different user profiles for the user's work and personal information and applications, an employer may enforce various security measures within the work profile to secure the work-related information and applications while allowing the user to configure the mobile computing device to apply a different set of security measures to the personal information and applications.

In other examples, a first user may share the mobile computing device with another user for a limited period of time (e.g., a guest user). Rather than permitting the guest user to access the first user's information and applications, the mobile computing device may be configured with a guest user profile that provides a configurable amount of access (e.g., limited access, full access, etc.) to the applications and information of the computing device. Responsive to the guest user no longer being the active user profile (e.g., logging out, logging into another user profile, etc.), the mobile computing device may be configured to automatically remove all application and user data stored at and/or generated by the mobile computing device while the guest user profile was the active user profile. Removing this application and user data may reduce the amount of information stored at the mobile computing device.

If used excessively, certain resources associated with computing devices, like battery and data transmission resources, can significantly impact device operation and user experience. Battery and data traffic usage can be even more significant if a computing device is configured for use by multiple users, as one user may use the device in ways that other users have no knowledge about or control over. For example, if a mobile computing device is on a limited data plan, one user could spend significant amounts time watching videos or streaming music, using up the amount of data available to both users on the plan without charge. In such a case, when an unexpected amount of data has been used on the phone, it can be useful to attribute the use to a particular user or a particular number of users.

In view of the impact of battery and data transmission resources and the benefits and complications associated therewith in a multi-user mobile computing device context, examples according to this disclosure include methods for collecting, by a mobile computing device, data indicative of battery and data transmission resources of the mobile device consumed as a result of use of various components of the device associated with one of multiple user profiles. Data indicating battery and data transmission resource consumption, and user profiles and mobile device components associated with the consumption may be collected for multiple time periods, e.g., hours, days, weeks, months, etc. The amount of consumption associated with particular users and device components may then be associated with particular periods of time. The mobile computing device can also be configured to generate and display one or more visual representations of the data indicating battery and data transmission resource consumption, and an indication of the associated user profiles, mobile device components, and particular time periods associated with the consumption.

In some examples of battery and data transmission resource recordation and presentation according to this disclosure, a method includes detecting, by a mobile computing device, use of a component of the mobile computing device. The use of the component is associated with a first user profile of a plurality of user profiles. The component of the mobile computing device can include a hardware and/or software component. The mobile computing device is configured to operate based at least in part on one or more configuration settings associated with one of the multiple user profiles at a time. The example method also includes determining at least one of an amount of data transmissions and power consumption of a battery of the mobile computing device caused by the detected use of the component of the mobile computing device, and generating a visual representation including the at least one of the amount of data transmissions and power consumption caused by the detected use of the component of the mobile computing device, the component of the mobile computing device detected as used in association with the first user profile, and the first user profile.

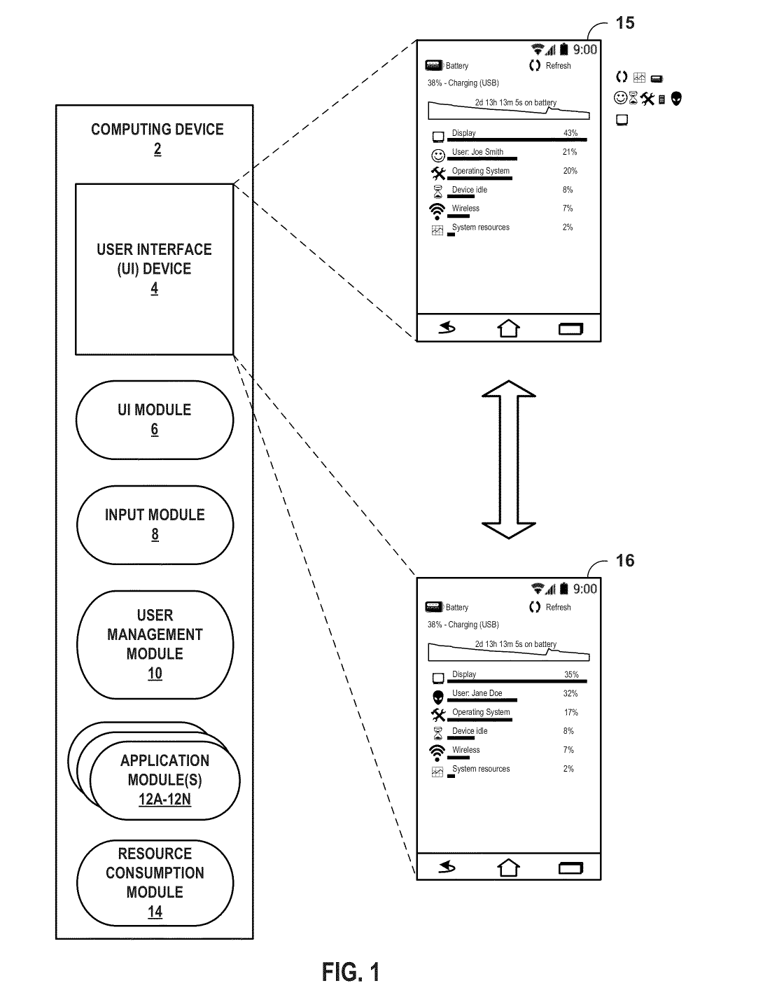

Once this data is collected, the mobile computing device can aggregate the data in various ways to show how the resource is used across applications and users. Example of such presentations are illustrated in FIGS. 1, 6, and 8, which show user interface screens that give details of the current user's applications, and a single summary of resource use for all applications executed by each other user. The mobile computing device may present the information other ways, such as expanding the information in response to input from a user so as to output a summary of all resource usage for one or more of the other users. For example, the mobile computing device may output the expanded information to include per-application details for each of the users. The ability of a mobile computing device to track battery and data transmission resources across multiple users in a multi-user mobile device context can allow individual users to understand how other users are using device resources that are being shared among the different users of the device.

FIG. 1 is a conceptual diagram illustrating an example computing device and example graphical user interfaces (GUIs) for displaying user-specific resource usage on the mobile computing device. Examples of computing device 2 may include, but are not limited to, portable or mobile devices such as mobile phones (including smart phones), laptop computers, desktop computers, tablet computers, smart television platforms, cameras, personal digital assistants (PDAs), servers, mainframes, etc. As shown in the example of FIG. 1, computing device 2 may be a tablet computer. Computing device 2, in some examples, can include user interface (UI) device 4, UI module 6, input module 8, user management module 10, application modules 12A-12N (collectively, “applications modules 12”), and resource consumption module 14. Other examples of computing device 2 that implement techniques of this disclosure may include additional components not shown in FIG. 1.

Computing device 2 may include UI device 4. In some examples, UI device 4 is configured to receive tactile, audio, or visual input. UI device 4, as shown in FIG. 1, may include a touch-sensitive and/or presence-sensitive device, such as a touch-sensitive and/or presence-sensitive display, or any other type of device for receiving input. In some examples, UI device 4 may output content such as graphical user interface (GUI) 15 and/or GUI 16 for display. In the example of FIG. 1, UI device 4 may be a presence-sensitive display that can display a graphical user interface and receive input from a user using capacitive, inductive, and/or optical detection at or near the presence sensitive display.

As shown in FIG. 1, computing device 2 may include UI module 6. UI module 6 may perform one or more functions to receive input, such as user input or network data, and send such input to other components associated with computing device 2, such as gesture module 8. For example, UI module 6 may determine a gesture performed by a user at or near UI device 4. UI module 6 may also receive data from components associated with computing device 2, such as input module 8. Using the data, UI module 6 may cause other components associated with computing device 2, such as UI device 4, to provide output based on the data. For instance, UI module 6 may receive data from input module 8 that causes UI device 4 to display information in text entry field of a GUI.

UI module 6 may be implemented in various ways. For example, UI module 6 may be implemented as a downloadable or pre-installed application or “app.” In another example, UI module 6 may be implemented as part of a hardware unit of computing device 2. In another example, UI module 6 may be implemented as part of an operating system of computing device 2.

Computing device 2, in some examples, includes input module 8. Input module 8 may include functionality to perform any one or more of a variety of operations on computing device 2. For instance, input module 8 may include functionality to determine gesture, keyboard, or other user inputs in accordance with the techniques described herein. Input module 8 may be implemented in various ways. For example, input module 8 may be implemented as a downloadable or pre-installed application or “app.” In another example, input module 8 may be implemented as part of a hardware unit of computing device 2. In another example, input module 8 may be implemented as part of an operating system of computing device 2.

Input module 8 may receive data from components associated with computing device 2, such as UI module 6. For instance, input module 8 may receive gesture data from UI module 6 that causes input module 8 to determine one or more actions to perform based on the gesture data. Input module 8 may also send data to components associated with computing device 2, such as UI module 6. For instance, input module 8 may send text determined based on the gesture data to UI module 6, which causes UI device 4 to display GUIs 15 and/or 16.

As shown in FIG. 1, GUIs 15 and 16 may be user interfaces generated by UI module 6 that allows a user to interact with computing device 2. GUIs 15 and 16 may include visual content. Visual content, generally, may include text, images, and/or a group of moving images, etc. For example, visual content may include pictorial, textual, numerical, and/or graphical representations of various types of information including, e.g., battery consumption, data transmissions, an indication of one or more user profiles, etc. In some examples, each of GUIs 15 and 16 may be associated with a different user profile associated with computing device 2. That is, UI module 6 may dynamically control UI device 4 to selectively display one of GUIs 15 and 16, including any user-specific content, based on a currently active user profile.

User management module 10 may manage one or more user profiles configured at computing device 2. For example, user management module 10 may create, modify, or delete user profiles configured at computing device 2, e.g., responsive to user input received by input module 8. In some instances, user management module 10 may control access to information stored at computing device 2 and associated with various user profiles configured at computing device 2 by, for example, authenticating user input received by user interface device 4 against stored authentication information associated with a particular user profile to determine whether to grant access to the user profile.

Multiple user profiles of computing device 2 may be employed by the device to adapt the operation of the computing device 2, including the presentation of information and execution of functions, to particular user profiles associated with particular users of the device computing 2. For example, user management module 10 may store in memory of computing device 2 configuration settings associated with each of a number of user profiles. Computing device 2 can be configured to operate based at least in part on the configuration settings associated with a user profile indicated as active by user management module 10, such that operations of computing device 2 change depending on which of the multiple user profiles managed by user management module 10 is active at any given time. Adapting operation of computing device 2 based on different user profiles can include, e.g., providing access to different end-user software and/or hardware applications and generation of user profile-specific user interface elements by UI module 6 and presentation thereof at UI device 4. For example, elements of a GUI generated by UI module 6 and presentation of the GUI at UI device 4 may change depending on the user profile according to which computing device 2 is operating at a given time. In some examples, UI module 6 generates a GUI and presents the GUI at UI device 4 that includes a wallpaper digital image that is specific to a particular user profile.

User profile-based adaptive operation of computing device 2 is also applied to tracking and managing battery and data transmission resources of computing device 2. In the example of FIG. 1, resource consumption module 14 can be configured to detect use of various components of computing device 2, e.g. software and/or hardware components, determine the amount of a resource consumed by the respective component, and associate the component use and resource consumption with a particular user profile associated with a particular user of device 2.

In some examples, resource consumption module 14 is configured to detect, for a component of computing device 2, use associated with a first user profile of multiple user profiles managed by user management module 10. Resource consumption module 14 and user management module 10 may be configured to communicate with one another such that resource consumption module 14 receives data from user management module 10 indicating the user profile according to which computing device 2 is currently configured to operate. Additionally, resource consumption module 14 can be configured to determine an amount of resource consumption caused by the detected use associated with the first user profile of the component of computing device 2. For example, resource consumption module 14 can be configured to determine an amount of power consumption of a battery of computing device 2 caused by a detected use associated with the first user profile of a hardware component, e.g., a display device of computing device 2. In another example, resource consumption module 14 is configured to determine an amount of data transmissions caused by a detected use associated with the first user profile of an end-user application, e.g., an e-mail application of computing device 2. As described in more detail below, resource consumption module 14 can be configured to detect use of components of computing device 2 and determine resource consumption associated with the use with software, hardware, or combinations thereof

Resource consumption module 14 can store data indicative of the detected use of components of computing device 2, an indication of the particular user profile associated with such use, and the amount of resource consumption caused by the component use associated with the user profile. The data stored by resource consumption module 14 can then be employed to render visual representations of the data, for example, to present to users of computing device 2 at UI device 4. In some examples, resource consumption module 14 communicates to UI module 6 data indicative of the detected use of components of computing device 2, the particular user profile associated with such use, and the amount of resource consumption caused by the component use associated with the user profile. UI module 6 can be configured to generate a visual representation of the resource consumption, an indication of the component of computing device 2 associated with the resource consumption, and an indication of the user profile associated with the consumption. UI module 6 can also be configured to control UI device 4 to display, e.g., at a display device, the visual representation of the resource consumption, the indication of the component of computing device 2 associated with the resource consumption, and the indication of the user profile associated with the consumption. User management module 10 and resource consumption module 14 may be components of an operating system executing on computing device 2 or may be incorporated within any other software component, such as an application of applications modules 12.

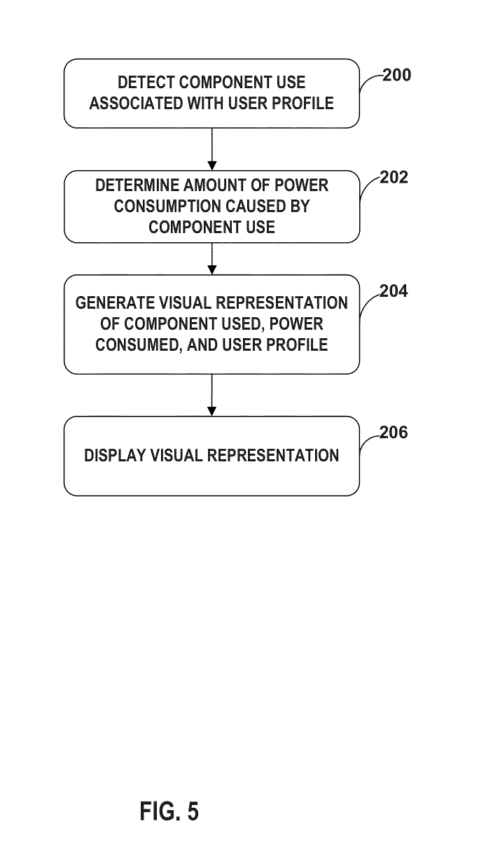

In FIG. 1, UI module 6 generates, and controls UI device 4 to display, GUI 15 and/or GUI 16, based on a currently active user profile. In the example of FIG. 1, GUI 15 and GUI 16 include a visual representation of power consumption of a battery of computing device 2 caused by use of various components of device 2. Additionally, GUI 15 and GUI 16 include visual representations that associate particular user profiles with the component use and power consumption caused thereby. For example, GUI 15 includes a visual representation that associates a first user profile indicated as “Joe Smith” with indications of use of various components of computing device 2 and power consumption caused thereby. GUI 16, on the other hand, includes a visual representation that associates a second user profile indicated as “Jane Doe” with indications of use of various components of computing device 2 and power consumption caused thereby. GUI 15 and GUI 16 include a combination of pictorial, textual, numerical, and graphical representations of the various elements associated with component use, resource consumption, and user profile. Examples of visual representations of user profile-specific component use and resource consumption are described in more detail below with reference to FIGS. 5-8.

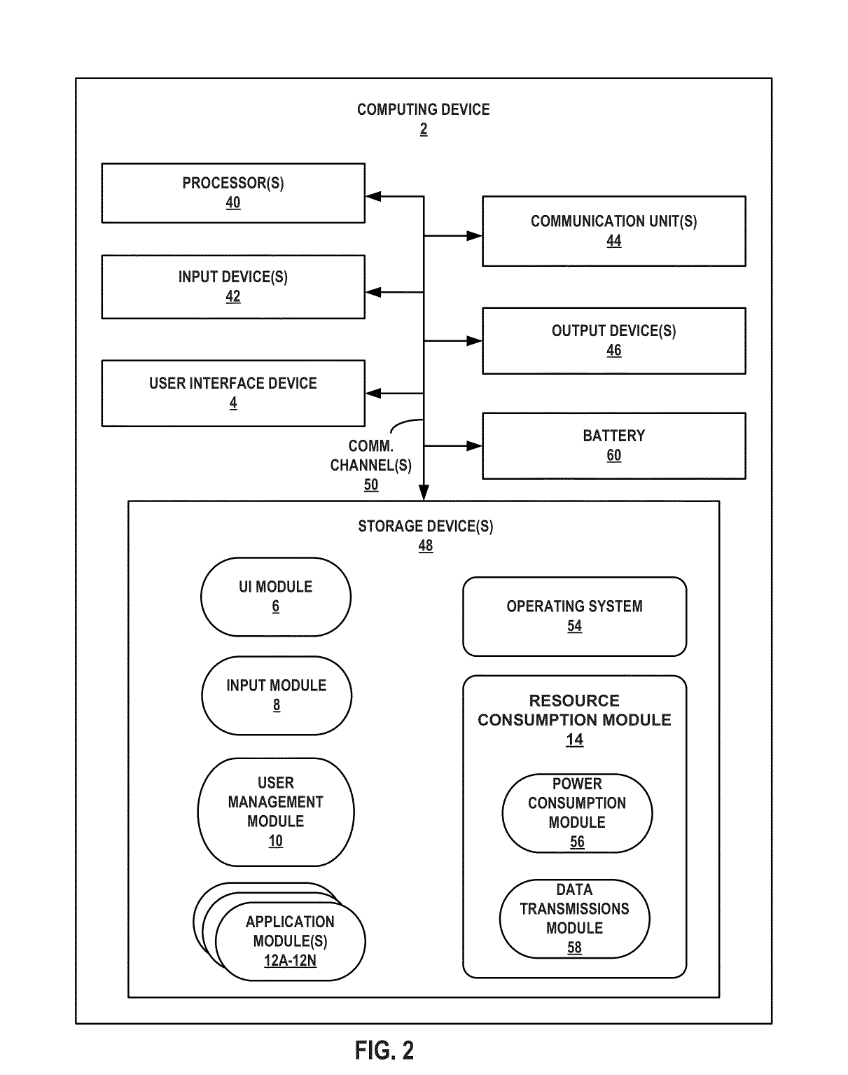

FIG. 2 is a block diagram illustrating further details of an example of computing device 2 shown in FIG. 1. FIG. 2 illustrates only one particular example of computing device 2, and many other examples of computing device 2 may be used in other instances. Moreover, although shown in FIGS. 1 and 2 as a stand-alone computing device 2 for purposes of example, a computing device may be any set of components or system that includes one or more processors 40 or other suitable computing environment for executing software instructions.

As shown in the example of FIG. 2, computing device 2 can include a computing system for providing an execution environment for executable software instructions. In this example, computing device 2 comprises UI device 4, one or more processors 40, one or more input devices 42, one or more communication units 44, one or more output devices 46, one or more storage devices 48, and battery 60. Each of components 4, 40, 42, 44, 46, 48, and 60 may be interconnected (physically, communicatively, and/or operatively) by communication channels 50 for inter-component communications. In some examples, communication channels 50 may include a system bus, a network connection, an inter-process communication data structure, or any other channel for communicating data. In some examples, communication channels 50 may interconnect components of computing device 2 for purposes other than communications. For example, communication channels 50 may include electrical connections between battery 60 and a measurement circuit that alone or in cooperation with processors 40 measures power consumption of battery 60 and stores data indicative of the amount of power consumed.

Processors 40, in some examples, are configured to implement functionality and/or process instructions for execution within computing device 2. For example, processors 40 may be capable of processing instructions stored in storage device 48. Examples of processors 40 may include any one or more of a microprocessor, a controller, a digital signal processor (DSP), an application specific integrated circuit (ASIC), a field-programmable gate array (FPGA), or equivalent discrete or integrated logic circuitry.

One or more storage devices 48 may be configured to store program code and/or data for use within computing device 2 during operation. In the example of FIG. 2, storage devices 48 store software components including operating system 54, UI module 6, input module 8, user management module 10, application modules 12, and resource consumption module 14. One more of storage devices 48, in some examples, is described as a computer-readable storage medium or a computer-readable storage device. In some examples, storage devices 48 include one or more temporary memories, meaning that a primary purpose of storage device 48 is not long-term storage. Storage devices 48, in some examples, may include a volatile memory, meaning that the memory does not maintain stored contents when the computer is turned off. Examples of volatile memories include random access memories (RAM), dynamic random access memories (DRAM), static random access memories (SRAM), and other forms of volatile memories known in the art. In some examples, one or more of storage devices 48 is used to store program instructions for execution by processors 40.

One or more storage devices 48, in an example, is used by software or applications running on computing device 2 (e.g., applications 12) to temporarily store information during program execution. Storage devices 48, in some examples, comprise one or more computer-readable storage media or computer-readable storage devices. In some examples, one or more of storage devices 48 may be configured to store larger amounts of information than volatile memory. One or more of storage devices 48 may further be configured for long-term storage of information. In some examples, one or more of storage devices 48 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 2 also includes one or more communication units 44. Computing device 2, in some examples, utilizes communication units 44 to communicate with external devices using one or more networks, such as one or more wireless networks. Communication units 44 may include a network interface card, such as an Ethernet card, an optical transceiver, a radio frequency transceiver, or any other types of devices that can send and receive information. Other examples of such network interfaces may include Bluetooth, 3G, and WiFi radios computing devices as well as Universal Serial Bus (USB). In some examples, computing device 2 utilizes one or more communication units 44 to wirelessly communicate with another computing device that is operably coupled to computing device 2. In accordance with some examples according to this disclosure, data transmitted from computing device 2 and received by computing device 2 via one or more communication units 44 may be attributed to use of components of computing device 2 and may be tracked to determine the amount of data transmissions caused by use associated with particular user profiles of different components of device 2.

Computing device 2, in some examples, also includes one or more input devices 42. One or more input devices 42, in some examples, are configured to receive input from a user through tactile, audio, or video feedback. Examples of input devices 42 include a presence-sensitive input device, such as a presence-sensitive display; a mouse; a keyboard; a voice responsive system; video camera; microphone; or any other type of device for detecting a command from a user. In some examples, a presence-sensitive device includes a touch-sensitive device.

One or more output devices 46 may also be included in computing device 2. One or more output devices 46, in some examples, are configured to provide output to a user using tactile, audio, and/or video stimuli. Output devices 46, in some examples, include a sound card, a video graphics adapter card, optical projector, a presence-sensitive display, or any other type of device for converting a signal into an appropriate form understandable to humans or machines. Additional examples of output devices 46 include a speaker, a cathode ray tube (CRT) monitor, a liquid crystal display (LCD), or any other type of device that can generate intelligible output to a user.

Operating system 54, in some examples, controls the operation of components of computing device 2. For example, operating system 54, in some examples, facilitates the communication of user management module 10 with processors 40, communication units 44, storage device 48, input device 42, and output device 46. One or more components of storage devices 48, including user management module 10 and applications 12, may each include program instructions and/or data that may be executable by computing device 2.

In the example of FIG. 2, computing device 2 includes resource consumption module 14, which includes power consumption module 56 and data transmissions module 58. Power consumption module 56 may be configured to measure and store the amount of power consumed from battery 60 by various functions and operations of computing device 2. Power consumption module 56 may also associate the use of components of computing device 2 that cause power consumption of battery 60 to particular user profiles. Similarly, data transmissions module 58 may be configured to measure and store the amount of transmitted from and received by communication units 44 as a result of the use of components of computing device 2, including, e.g., hardware and/or software components. Data transmissions module 58 may also associate the use of components of computing device 2 that cause data transmissions to/from communication units 44 to particular user profiles.

In some examples, power consumption module 56 is configured to determine the amount of power consumption of battery 60 of computing device 2 and communication data indicative of such consumption to UI module 6, which, in turn, can generate visual representations of power consumption data for display at output device 46, e.g., at a display device. For example, power consumption module 56 can be configured to detect the use of hardware or other components of computing device 2. The use of a component of computing device 2 can be detected, e.g., by measuring power drawn by the component, detecting activities performed by applications 12 with a hardware component of computing device 2, or detecting communications, such as instructions, to the hardware component from another component of computing device.

In some examples, the amount of power use attributable to the use of the component may be directly determined. For example, a power circuit between battery 60 and the hardware component, e.g., processors 40, may include a small resistor across which a voltage drop can be measured. Using the measured voltage drop and the known resistance of the resistor, power consumption module 56 can determine the amount of current being drawn by the component. Then, using the current being drawn and the known voltage of battery 60, power consumption module 56 can determine amount of power being drawn by the component.

In other examples, power consumption module 56 executes instructions that are configured to convert characteristics of operations and/or functions executed at computing device 2 into an amount of power consumption of battery 60. For example, after detecting use of a component of computing device 2, power consumption module 56 can execute instructions that convert characteristics of the detected use of the component into an amount of power consumption of battery 60. The instructions can relate the detected use of the component, e.g., type of use, duration of use, etc., into an estimated power consumption. The instructions may be based on, e.g., previously measured power consumption of similar or the same operations and/or functions by the same or a similar device.

In some examples, power consumption module 56 detects activation of a display device included in output devices 46. For example, power consumption module 56 can detect activation of a backlight of an LCD display device by detecting an increased power draw from battery 60 by the display or detecting messages, e.g., commands, from one or more processors 40 to the display to turn on the backlight. In such a case, power consumption module 56 can continue monitoring the activation of the LCD display for a period of time and determine a total amount of power consumed from battery 60 as a result of the display activation.

In some examples, power consumption module 56 executes an algorithm that converts display activation for a determined amount of time into an amount of power consumption from battery 60. In some instances, algorithms executed by power consumption module 56 to convert component use into power consumption data may be configured to consider more than the use of a particular component and the amount of time the component is used. For example, the character of the use of processors 40, e.g., operating frequencies and associated voltage planes, can vary for different functions, operating states, or resource loads, and the amount of power drawn from battery 60 can similarly vary, not only based on the amount of time processors 40 are executing the function, but also based on the operating frequency of processors 40. Regardless of the manner by which power consumption module 56 determines the amount of power consumption attributable to a component, power consumption module 56 can then store data indicating the amount of power consumption, e.g., on memory included in storage devices 48.

Data transmissions module 58 can be configured to operate in a manner similar to power consumption module 56, except with respect to determining the amount of data transmissions to and/or from communication units 44 caused by use associated with particular user profiles of components of computing device 2. In some examples, data transmissions module 58 is configured to determine the amount of data transmissions to and/or from communication units 44 and communicate data indicative of such data transmissions to UI module 6, which, in turn, can generate visual representations of data transmission data for display at output device 46, e.g., at a display device. For example, data transmissions module 58 can be configured to detect the use of hardware or other components of computing device 2. The use of a component of computing device 2 can be detected, e.g., by measuring power drawn by the component, detecting activities performed by applications 12 using a hardware component of computing device 2, or detecting communications, such as instructions, to the hardware component.

In some examples, data transmissions module 58 is configured to, upon detection of the use of a component of computing device 2, monitor operations of communication units 44 and measure the amount of data transmitted as a result of the detected use of the component. For example, data transmissions module 58 may detect the use of an end-user application included in application modules 12. Data transmissions module 58 could detect use of one of application modules 12, e.g., by monitoring messages, processes, or other operations associated with the one of application modules 12 indicating use. For example, data transmissions module 58 can detect the use of an e-mail client application by monitoring instructions executed by one or more processors 40. Upon detection of the use of the e-mail client, data transmissions module 58 can, in some examples, monitor operations of communications units 44 and measure the amount of data transmitted to and/or from communications units 44. Data transmissions module 58 can then associate the use of the e-mail client and the amount of data transmitted to and/or from communications units 44 during detected operation of the e-mail client with the use of the e-mail client.

In some examples, power consumption module 56 and/or data transmissions module 58, in conjunction with user management module 10, can associate the detected use of a component of computing device 2 and the power of battery 60 consumed thereby or the data transmissions to and/or from communication units 44 resulting therefrom, respectively, with a particular user profile. In some examples, power consumption module 56 and/or data transmissions module 58, in conjunction with user management module 10, can identify the user profile as an active one of the plurality of user profiles when the use of the component of computing device 2 occurred.

For example, various applications, processes, and other functions, including core system processes that are executed at computing device 2, e.g., by processors 40, each may be mapped to a unique identification code, such as a unique integer. In some examples, a unique identifier (ID) is mapped to each application and is also mapped to each user profile of computing device 2. In such cases, a single application, process, or other function executed at computing device 2 may be mapped to multiple unique ID's corresponding to multiple different user profiles.

In some examples, execution of each application (or process or other function) associated with the use of a component of computing device 2 may automatically invoke the unique ID of that application. For example, functions executed by an application may include within function calls of the application the unique ID of the application such that detection of the use of the application also indicates the unique ID of the application. Thus, resource consumption module 14, including power consumption module 56 and data transmissions module 58, can detect use of a component by detecting use of an application (or process or other function) associated therewith, and such detection may automatically indicate the unique ID of the application.

In some examples, identification of a user profile as the active profile at the time of component use and resource consumption caused thereby can be made at any point in time after the unique ID of an application associated with the detected component use is determined. In some examples, user management module 10 may receive a unique ID associated with an application, the use of which is associated with a detected use of a component from resource consumption module 14. User management module 10 or another module or component can be configured to reference a database or other data storage and retrieval mechanism mapping applications, unique ID's, and user profiles. For example, after or while detecting use of an application corresponding to use of a component of computing device 2, user management module 10 can be configured to send a database query to a database mapping applications to unique ID's and user profiles. The database query can be configured to return to user management module 10 the user profile associated with unique ID of the application that was or is being used. In some examples, identification of user profiles as the active profile at the time of component use are made during the generation of a visual representation of resource consumption, component use causing such consumption, and the user profile that is identified as active at the time the component use occurred.

Although described above as executed by each of power consumption module 56 and data transmissions module 58, in some examples, component use detection may be executed by a module separate therefrom. In such a case, the separate component use detection module can be configured to communicate data indicative of component use to power consumption module 56 and data transmissions module 58 for use in determining the amount of resources consumed by such use.

Resource consumption module 14, including power consumption module 56 and data transmissions module 58, can be configured to store data indicative of the detected use of components of computing device 2, the particular user profile associated with the component use, and the amount of resource consumption caused by the component use associated with the user profile. The data stored by resource consumption module 14 can then be employed to render visual representations of the data, for example, to present to users of computing device 2 at UI device 4. In some examples, resource consumption module 14 communicates data to UI module 6 indicative of the detected use of components of computing device 2, the particular user profile associated with the component use, and the amount of resource consumption caused by the component use associated with the user profile. UI module 6 can be configured to generate a visual representation of the resource consumption and the component of computing device 2 and user profile associated with such consumption. UI module 6 can also be configured to control UI device 4 to display, e.g., at a display device, the visual representation of the resource consumption, an indication of the component of computing device 2, and an indication of the user profile associated with such consumption. Examples of visual representations of user profile-specific component use and resource consumption are described in more detail below with reference to FIGS. 5-8.

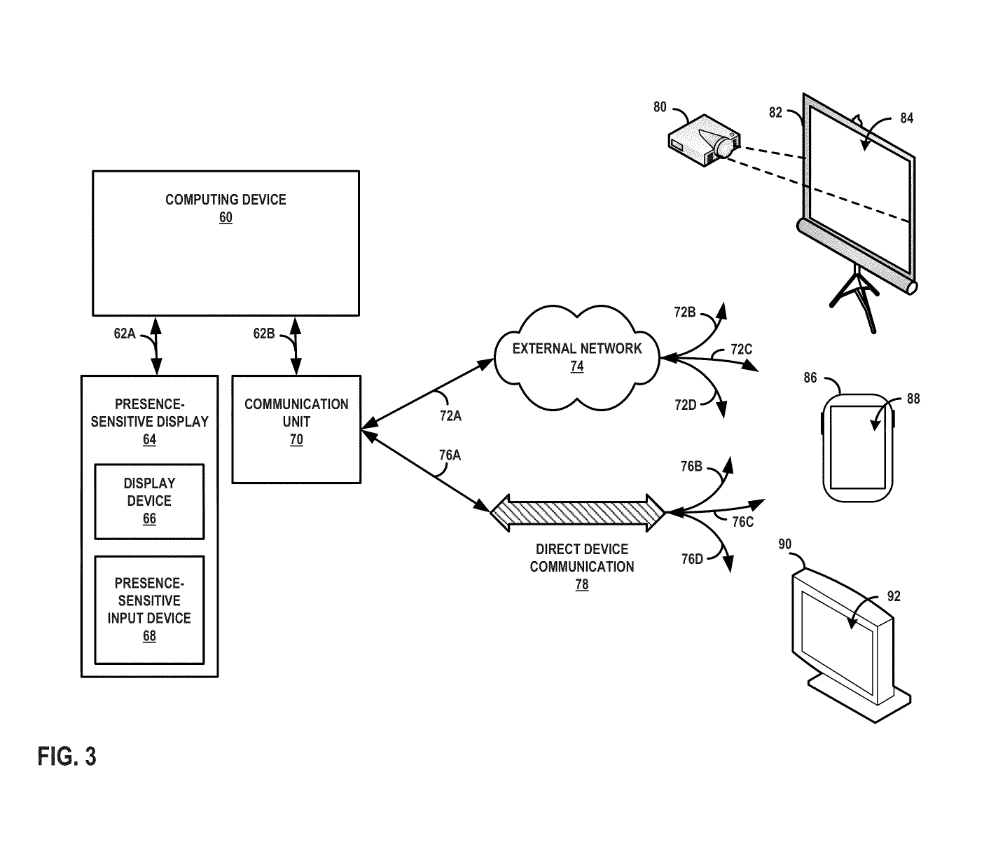

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 3 includes a computing device 60, presence-sensitive display 64, communication unit 70, projector 80, projector screen 82, mobile device 86, and visual display device 90. Although shown for purposes of example in FIGS. 1 and 2 as a stand-alone computing device 2, a computing device such as computing device 60 may, generally, be any component or system that includes a processor or other suitable computing environment for executing software instructions and, for example, need not include a presence-sensitive display.

As shown in the example of FIG. 3, computing device 60 may be a processor that includes functionality as described with respect to processors 40 in FIG. 2. In such examples, computing device 60 may be operatively coupled to presence-sensitive display 64 by a communication channel 62A, which may be a system bus or other suitable connection. Computing device 60 may also be operatively coupled to communication unit 70, further described below, by a communication channel 62B, which may also be a system bus or other suitable connection. Although shown separately as an example in FIG. 3, computing device 60 may be operatively coupled to presence-sensitive display 64 and communication unit 70 by any number of one or more communication channels.

In other examples, such as illustrated previously by computing device 2 in FIGS. 1-2, a computing device may refer to a portable or mobile device such as mobile phones (including smart phones), laptop computers, etc. In some examples, a computing device may be a desktop computer, tablet computer, smart television platform, camera, personal digital assistant (PDA), server, mainframe, etc.

Presence-sensitive display 64, like presence-sensitive display 4 as shown in FIG. 1, may include display device 66 and presence-sensitive input device 68. Display device 66 may, for example, receive data from computing device 60 and display the graphical content. In some examples, presence-sensitive input device 68 may determine one or more user inputs (e.g., continuous gestures, multi-touch gestures, single-touch gestures, etc.) at presence-sensitive display 64 using capacitive, inductive, and/or optical recognition techniques and send indications of such user input to computing device 60 using communication channel 62A. In some examples, presence-sensitive input device 68 may be physically positioned on top of display device 66 such that, when a user positions an input unit over a graphical element displayed by display device 66, the location at which presence-sensitive input device 68 corresponds to the location of display device 66 at which the graphical element is displayed. In other examples, presence-sensitive input device 68 may be positioned physically apart from display device 66, and locations of presence-sensitive input device 68 may correspond to locations of display device 66, such that input can be made at presence-sensitive input device 68 for interacting with graphical elements displayed at corresponding locations of display device 66.

As shown in FIG. 3, computing device 60 may also include and/or be operatively coupled with communication unit 70. Communication unit 70 may include functionality of communication unit 44 as described in FIG. 2. Examples of communication unit 70 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 60 may also include and/or be operatively coupled with one or more other devices, e.g., input devices, output devices, memory, storage devices, etc. that are not shown in FIG. 3 for purposes of brevity and illustration.

FIG. 3 also illustrates a projector 80 and projector screen 82. Other examples of projection devices may include electronic whiteboards, holographic display devices, and any other suitable devices for displaying graphical content. Projector 80 and projector screen 82 may include one or more communication units that enable the respective devices to communicate with computing device 60. In some examples, the one or more communication units may enable communication between projector 80 and projector screen 82. Projector 80 may receive data from computing device 60 that includes graphical content. Projector 80, in response to receiving the data, may project the graphical content onto projector screen 82. In some examples, projector 80 may determine one or more user inputs (e.g., continuous gestures, multi-touch gestures, single-touch gestures, etc.) at projector screen using optical recognition or other suitable techniques and send indications of such user input using one or more communication units to computing device 60. In such examples, projector screen 82 may be unnecessary, and projector 80 may project graphical content on any suitable medium and detect one or more user inputs using optical recognition or other such suitable techniques.

Projector screen 82, in some examples, may include a presence-sensitive display 84. Presence-sensitive display 84 may include a subset of functionality or all of the functionality of UI device 4 as described in this disclosure. In some examples, presence-sensitive display 84 may include additional functionality. Projector screen 82 (e.g., an electronic whiteboard), may receive data from computing device 60 and display the graphical content. In some examples, presence-sensitive display 84 may determine one or more user inputs (e.g., continuous gestures, multi-touch gestures, single-touch gestures, etc.) at projector screen 82 using capacitive, inductive, and/or optical recognition techniques and send indications of such user input using one or more communication units to computing device 60.

FIG. 3 also illustrates mobile device 86 and visual display device 90. Mobile device 86 and visual display device 90 may each include computing and connectivity capabilities. Examples of mobile device 86 may include e-reader devices, convertible notebook devices, hybrid slate devices, etc. Examples of visual display device 90 may include other semi-stationary devices such as televisions, computer monitors, etc. As shown in FIG. 3, mobile device 86 may include a presence-sensitive display 88. Visual display device 90 may include a presence-sensitive display 92. Presence-sensitive displays 88, 92 may include a subset of functionality or all of the functionality of presence-sensitive display 4 as described in this disclosure. In some examples, presence-sensitive displays 88, 92 may include additional functionality. In any case, presence-sensitive display 92, for example, may receive data from computing device 60 and display the graphical content. In some examples, presence-sensitive display 92 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 60.

As described above, in some examples, computing device 60 may output graphical content for display at presence-sensitive display 64, which is coupled to computing device 60 by a system bus or other suitable communication channel. Computing device 60 may also output graphical content for display at one or more remote devices, such as projector 80, projector screen 82, mobile device 86, and visual display device 90. For instance, computing device 60 may execute one or more instructions to generate and/or modify graphical content in accordance with techniques of the present disclosure. Computing device 60 may output the data that includes the graphical content to a communication unit of computing device 60, such as communication unit 70. Communication unit 70 may send the data to one or more of the remote devices, such as projector 80, projector screen 82, mobile device 86, and/or visual display device 90. In this way, computing device 60 may output the graphical content for display at one or more of the remote devices. In some examples, one or more of the remote devices may output the graphical content at a display device, such as a presence-sensitive display, that is included in and/or operatively coupled to the respective remote device.

In some examples, computing device 60 may not output graphical content at presence-sensitive display 64 that is operatively coupled to computing device 60. In other examples, computing device 60 may output graphical content for display at both a presence-sensitive display 64 that is coupled to computing device 60 by communication channel 62A, and at a display of one or more the remote devices. In such examples, the graphical content may be displayed substantially contemporaneously at each respective device. For instance, some delay may be introduced by the communication latency to send the data that includes the graphical content to the remote device. In some examples, graphical content generated by computing device 60 and output for display at presence-sensitive display 64 may be different than graphical content display output for display at one or more remote devices.

Computing device 60 may send and receive data using any suitable communication techniques. For example, computing device 60 may be operatively coupled to external network 74 using network link 72A. Each of the remote devices illustrated in FIG. 3 may be operatively coupled to network external network 74 by one of respective network links 72B, 72C, and 72D. External network 74 may include network hubs, network switches, network routers, etc., that are operatively inter-coupled thereby providing for the exchange of information between computing device 60 and the remote devices illustrated in FIG. 3. In some examples, network links 72A-72D may be Ethernet, ATM or other network connections. Such connections may be wireless and/or wired connections.

In some examples, computing device 60 may be operatively coupled to one or more of the remote devices included in FIG. 3 using direct device communication 78. Direct device communication 78 may include communications through which computing device 60 sends and receives data directly with a remote device, using wired or wireless communication. That is, in some examples of direct device communication 78, data sent by computing device 60 may not be forwarded by one or more additional devices before being received at the remote device, and vice-versa. Examples of direct device communication 78 may include Bluetooth, Near-Field Communication, Universal Serial Bus, infrared, etc. One or more of the remote devices illustrated in FIG. 3 may be operatively coupled with computing device 60 by communication links 76A-76D. In some examples, communication links 76A-76D may be connections using Bluetooth, Near-Field Communication, Universal Serial Bus, infrared, etc. Such connections may be wireless and/or wired connections.

In accordance with techniques of the disclosure, computing device 60 may be operatively coupled to one or more of the remote devices, such as projector 80, projector screen 82, mobile device 86, and/or visual display device 90, using external network 74. Computing device 60 can be configured to detect resource (e.g., power or data transmissions) use by a component of computing device 60 and associate that detected resource use with the component and a user profile, such as an active user profile at the time at which the component was detected to consume the resource. Computing device 60 also may be configured to output data that includes a graphical representation of an indication of the component, the resource use, and an indication of the associated user profile to communication unit 70. Communication unit 70 may send the data that includes the representation of the indication of the component, the resource use, and the indication of the associated user profile to one or more of the remote devices, such as projector 80, projector screen 82, mobile device 86, and/or visual display device 90 using external network 74. A display device of the one or more of the remote devices, such as projector 80, projector screen 82, mobile device 86, and/or visual display device 90, in response to receiving the data using external network 74, may cause the associated display device to output the graphical representation of the component, the indication of the resource use, and the indication of the associated user profile.

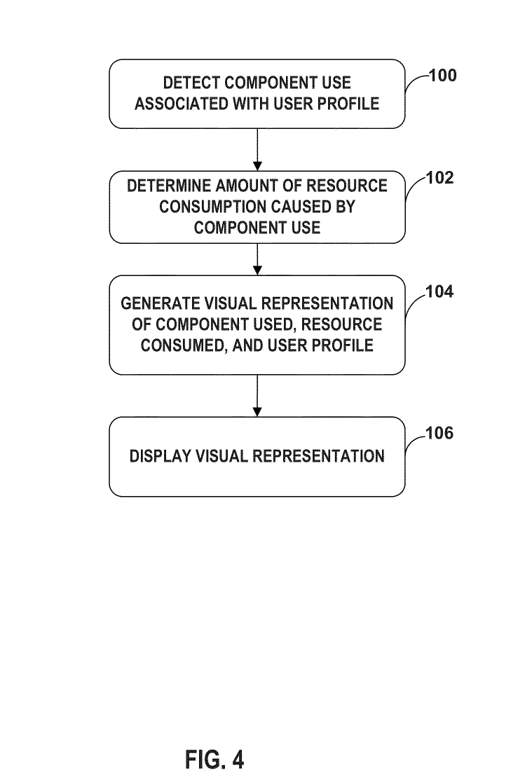

FIG. 4 is a flowchart illustrating an example method according to this disclosure. The example method of FIG. 4 includes detecting use of a component of a mobile computing device associated with a first user profile of a plurality of user profiles (100), determining an amount of resource consumption for a resource associated with the mobile computing device that is caused by the detected use associated with the first user profile of the component of the mobile computing device (102), generating a visual representation including the amount of resource consumption caused by the detected use associated with first user profile of the component of the mobile computing device, an indication of the component of the mobile computing device detected as used in association with the first user profile, and an indication of the first user profile (104), and displaying the visual representation (106).

In some examples, the method of FIG. 4 may be employed to detect use associated with a particular user profile of a component of a mobile computing device, determine the amount of power consumption of a battery of the device caused by the usage, and generate of a visual representation of an indication of the component, the power consumption, and an indication of the user profile. In another example, the method of FIG. 4 may be employed to detect use associated with a particular user profile of a component of a mobile computing device, determine the amount of data transmissions to and/or from the mobile computing device caused by the usage, and generate of a visual representation of an indication of the component, the amount of data transmissions, and an indication user profile. More details of the foregoing two examples are illustrated in and described with reference to FIGS. 5-8.

FIG. 5 is a flowchart illustrating another example method according to this disclosure. The example method of FIG. 5 includes detecting use of a component of a mobile computing device associated with a first user profile of a plurality of user profiles (200), determining an amount of power consumption of a battery of the mobile computing device caused by the detected use of the component of the mobile computing device associated with the first user profile (202), generating a visual representation including the amount of power consumption caused by the detected use of the component of the mobile computing device associated with first user profile, an indication of the component of the mobile computing device detected as used in association with the first user profile, and an indication of the first user profile (204), and displaying the visual representation (206).

In some examples, power consumption module 56 can be configured to detect the use of hardware or other components of computing device 2 (200). The use of a component of computing device 2 can be detected, e.g., by measuring power drawn by the component, detecting activities performed by one or more of application modules 12 with a hardware component of computing device 2, or detecting communications such as instructions to the hardware component.

Power consumption module 56 can also be configured to determine the amount of power consumption of battery 60 caused by the detected use of the component of computing device 2 (202). In some examples, power consumption module 56 executes instructions that are configured to convert characteristics of operations/functions executed at computing device 2 into an amount of power consumption of battery 60. In some examples, power consumption module 56 detects activation of a display device included in output devices 46. For example, power consumption module 56 can detect activation of a backlight of an LCD display device by detecting an increased power draw from battery 60 by the display or detecting messages, e.g., commands from processors 40 to the display to turn on the backlight. In such a case, power consumption module 56 can continue monitoring the activation of the LCD display for a period of time and determine a total amount of power consumed from battery 60 as a result of the display activation. In some examples, power consumption module 56 executes an algorithm that converts display activation for a determined amount of time into an amount of power consumption from battery 60. Algorithms executed by power consumption module 56 to convert component use into power consumption data may be configured to consider more than the use of a particular component and the amount of time the component is used. For example, the character of the use of processors 40, e.g., operating frequencies and associated voltage planes, can vary for different functions, operating states, or resource loads, and the amount of power drawn from battery 60 can also vary, not only based on the amount of time processors 40 are executing a function, but also based on the operating frequency of the processors 40.

Power consumption module 56 can be configured to communicate data indicative of the detected use of components of computing device 2, the particular user profile associated with such use, and the amount of power consumption of battery 60 caused by the component use associated with the user profile. In some examples, resource consumption module 14 communicates data to UI module 6 indicative of the detected use of components of computing device 2, the particular user profile associated with such use, and the amount of resource consumption caused by the component use associated with the user profile. UI module 6 can be configured to generate a visual representation of the power consumption, an indication of the component of computing device 2, and an indication of the user profile associated with such consumption (204). In the process of generating the visual representation of the power consumption, the indication of the component of computing device 2, and the indication of the user profile associated with the consumption, user management module 10 can identify the user profile active at the time the component use occurred and can communicate an indication of the identified user profile to UI module 6. UI module 6 can also be configured to control UI device 4 to display, e.g., at a touch-sensitive display device the visual representation of the resource consumption, the indication of the component of computing device 2, and the indication of the user profile associated with such consumption (206).

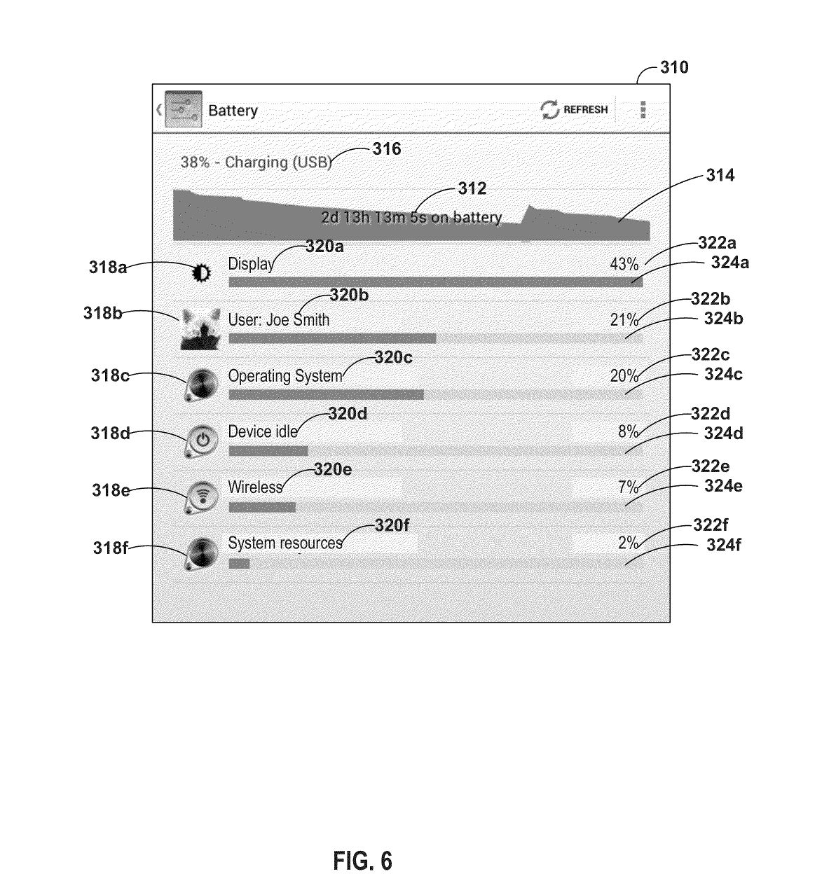

An example of a visual representation including the amount of power consumption of battery 60 caused by the detected use of the component of computing device 2 associated with the first user profile, the indication of the component of computing device 2 detected as used in association with the first user profile, and the indication of the first user profile is illustrated in FIG. 6. In particular, FIG. 6 is a screenshot illustrating an example GUI 310 generated and displayed as part of the example method of FIG. 5. GUI 310 includes various types of visual content that represents the amount of power consumption of battery 60 caused by the detected use of the component of computing device 2 associated with the first user profile, the indication of the component of computing device 2 detected as used in association with the first user profile, and the indication of the first user profile. For example, GUI 310 includes pictorial, textual, numerical, and graphical representations of power consumption, the indication of the component, and the indication of the user profile.

In FIG. 6, GUI 310 also includes the total amount of time over which power consumption, component use, and the associated user profile was monitored. As noted above, tracking resource consumption caused by component use and associating the resource consumption with particular user profiles can be performed over various periods of time and data associated with such functions can be stored for each of the periods of time over which it is tracked. GUI 310 includes numerical representation 312 indicating a total amount of time on battery 60 of computing device 2 of 2 days, 13 hours, 13 minutes, and 5 seconds. GUI 310 also includes numerical representation 316 indicating the amount of time battery 60 was charging over this period of time (as a percentage of the total time). GUI 310 includes graphical representation 314 of the charge level of battery 60 over the tracked period of time.

GUI 310 also includes visual content representing component use, power consumption caused by the component use, and the indication of the first user profile. In the example illustrated in FIG. 6, power consumption caused by components generic to different user profiles, such as the display device, the operating system, device idle processes, wireless components, and system resource components, are displayed separately, and power consumption of components whose use is specific to the user profile labeled “Joe Smith” is grouped under the user profile indication “Joe Smith.” For example, GUI 310 includes pictorial representation 318a and textual representation 320a of a display device of UI device 4 of computing device 2, and the corresponding power consumption in textual representation 322a and graphical representation 324a. GUI 310 includes similar representations for the power consumption of the operating system (identifier pictorial representation 318c and textual representation 320c, and power consumption textual representation 322c and graphical representation 324c), device idle processes (identifier pictorial representation 318d and textual representation 320d, and power consumption textual representation 322d and graphical representation 324d), wireless communication components (identifier pictorial representation 318e and textual representation 320e, and power consumption textual representation 322e and graphical representation 324e), and system resources (identifier pictorial representation 318f and textual representation 320f, and power consumption textual representation 322f and graphical representation 324f). In other examples, however, the proportional power consumption of one or more of these components could be associated with individual user profiles and the respective individual amounts of power consumption caused by such uses could be displayed separately.

Additionally, GUI 310 includes pictorial representation 318b and textual representation 320b of the first user profile, labeled “Joe Smith,” associated with the use of some components of computing device 2. GUI 310 also includes numerical representation 32b and graphical representation 324b of the amount of power consumption of battery 60 associated with the first user profile, labeled “Joe Smith” (e.g., caused by use of components of computing device 2 and associated with the “Joe Smith” user profile). In the example of FIG. 6, all component uses associated with the first user profile, labeled “Joe Smith,” are collected together, and a total amount of power consumption of battery 60 associated with the first user profile is displayed as part of GUI 310. In other examples, however, the individual components used and associated with the first user profile and the respective individual amounts of power consumption caused by such uses could also be displayed. For example, a graphical representation of the total power consumption of battery 60 could be shown, as illustrated in FIG. 6, along with further detail regarding which specific components accounted for what percentage of the total power consumption of battery 60 associated with the first user profile.

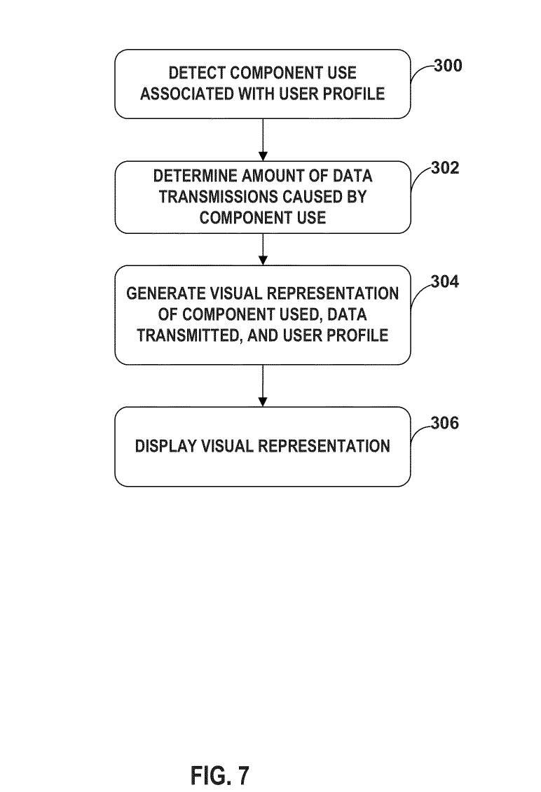

FIG. 7 is a flowchart illustrating another example method according to this disclosure. The example method of FIG. 7 includes detecting use of a component of a mobile computing device associated with a first user profile of a plurality of user profiles (300), determining an amount of data transmissions caused by the detected use associated with the first user profile of the component of the mobile computing device (302), generating a visual representation including the amount of data transmissions caused by the detected use associated with first user profile of the component of the mobile computing device, an indication of the component of the mobile computing device detected as used in association with the first user profile, and an indication of the first user profile (304), and displaying the visual representation (306).

In some examples, data transmission module 58 can be configured to detect the use of hardware or other components of computing device 2 (200). The use of a component of computing device 2 can be detected, e.g., by measuring power drawn by the component, detecting activities performed by one or more of application modules 12 with a hardware component of computing device 2, or detecting communications such as instructions to the hardware component.

In some examples, data transmissions module 58 is configured to, upon detection of the use of a component of computing device 2, monitor operations of communication units 44 and determine the amount of data transmitted as a result of the detected use of the component (202). For example, data transmissions module 58 may detect the use of an end-user application included in application modules 12 executed at computing device 2. Data transmissions module 58 module can detect use of one of application modules 12, e.g., by monitoring messages, processes, or other operations associated with the application and indicating use thereof. For example, data transmissions module 58 can detect the use of an e-mail client application. Upon detection of the use of the e-mail client, data transmissions module 58 can, in some examples, monitor operations of communications units 44 and determine the amount of data transmitted to and/or from communications units 44 as a result of the use of the e-mail client.

Data transmission module 58 can be configured to communicate data indicative of the detected use of components of computing device 2, the particular user profile associated with such use, and the amount of data transmitted as a result of the component use associated with the user profile. In some examples, data transmission module 58 communicates the data to UI module 6. UI module 6 can be configured to generate a visual representation of the data transmissions, an indication of the component of computing device 2, and an indication of the user profile associated with such consumption (204). In the process of generating the visual representation of the data transmissions, the indication of the component of computing device 2, and the indication of the user profile associated with such consumption, user management module 10 can identify the user profile active at the time the component use occurred and can communicate the identified user profile to UI module 6. UI module 6 can also be configured to control UI device 4 to display, e.g., at a touch-sensitive display device the visual representation of the resource consumption, the indication of the component of computing device 2, and the indication of the user profile associated with the consumption (206).

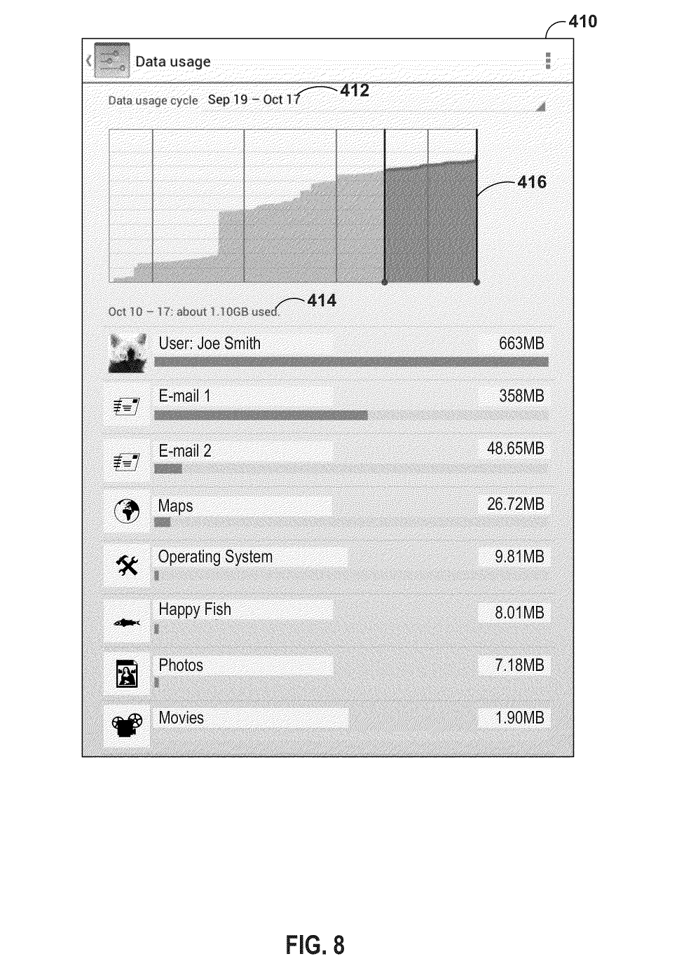

An example of a visual representation including the amount of data transmissions to and/or from communications units 44 of computing device 2 caused by the detected use of the component of device 2 associated with the first user profile, the indication of the component of computing device 2 detected as used in association with the first user profile, and the indication of the first user profile is illustrated in FIG. 8. In particular, FIG. 8 is a screenshot illustrating an example GUI 410 generated and displayed as part of the example method of FIG. 7. GUI 410 includes various types of visual content that represents the indication of the first user profile, the indications of the components of computing device 2 detected as used in association with the first user profile, and the amount of data transmissions caused by the detected use of the respective components. For example, GUI 410 includes pictorial, textual, numerical, and graphical representations of the amount of data transmissions, the indications of component use, and the indications of user profiles in a similar manner as GUI 310 of FIG. 6.

In FIG. 8, GUI 410 also includes the total amount of time over which the amount of data transmissions, component use, and the first user profile was monitored. As noted above, tracking resource consumption caused by component use associated with particular user profiles can be executed over various periods of time and data associated with such functions can be stored for each of the periods of time over which it is tracked. GUI 410 includes textual representation 412 indicating a total amount of time over which data transmissions occurred and textual representation 414 indicating a subset of the total amount of time and the corresponding data transmissions during this subset of time.

GUI 410 also includes visual content representing indications of component use, data transmissions resulting from the component use, and the indications of the user profile associated with the use. For example, GUI 410 includes graphical representation 416 indicating both the total amount of time and subsets thereof over which data transmissions were tracked. Graphical representation 416 also indicates the total amount of data transmissions over the time period. Similar to GUI 310 of FIG. 6, GUI 410 includes pictorial representations and textual representations of indications of the components used over the period of time in association with the user profile. In particular, GUI 410 includes pictorial and textual representations for various application modules used in association with the first user profile.

GUI 410 also includes a pictorial representation and textual representation of the user profile, labeled “Joe Smith,” associated with the use of the application modules of computing device 2. Again similar to GUI 310 of FIG. 6, GUI 410 includes numerical and graphical representations of the amount of data transmissions caused by individual components (application modules in this example) of computing device 2 and associated with the user profile, labeled “Joe Smith.” In the example of FIG. 8, indications of the individual components used and associated with the user profile and the respective individual amounts of data transmissions caused by such uses are displayed. Additionally, GUI 410 includes a representation of the total amount of data transmissions caused by all component uses associated with the user profile, labeled “Joe Smith.”

The examples of FIGS. 5-8 are described with reference to component uses and resource consumption associated with one of multiple user profiles. However, the foregoing functions can be repeated for any number including all of the user profiles of a computing device. Additionally, the manner in which visual representations of component use, resource consumption, and user profiles is generated and displayed may accommodate data related to multiple user profiles. For example, GUI 310, GUI 410, or other such visual representations may include data for not just one user profile but multiple such that not only can individual user profiles be correlated to component use and resource consumption caused thereby, but, additionally, component use and resource consumption associated with multiple user profiles can be compared to one another.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium or computer-readable storage device encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable storage media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
detecting, by a mobile computing device, for at least two respective user profiles of a plurality of user profiles, use of a component of the mobile computing device associated with the respective user profile, wherein the component comprises at least one of a hardware or a software component of the mobile device, and wherein the mobile computing device is configured to operate, at a given time, based at least in part on one or more configuration settings associated with one user profile of the plurality of user profiles;
determining, by the mobile computing device, for each of the at least two respective user profiles, resource consumption caused by the detected use of the component of the mobile computing device over a period of time, wherein the resource consumption comprises at least one of an amount of data transmissions and power consumption of a battery of the mobile computing device; and
generating, by the mobile computing device, for at least one of the at least two respective user profiles, a visual representation comprising an indication of the resource consumption caused by the detected use of the component associated with one of the respective user profiles, an indication of the component associated with the resource consumption associated with the one of the respective user profiles, an indication of the one of the respective user profiles, and an indication of the period of time.

2. The method of claim 1, wherein the visual representation comprises a pictorial representation the indication of the component associated with the resource consumption associated with the one of the respective user profiles, at least one of a graphical or numerical representation of the indication of the resource consumption caused by the detected use of the component associated with the one of the respective user profiles, a pictorial representation of the indication of the one of the respective user profiles, and a numerical representation of the period of time.

3. The method of claim 2, wherein the visual representation further comprises a textual representation of the indication of the one of the respective user profiles and a graphical representation of the period of time.

4. The method of claim 2, wherein the pictorial representation of the indication of the component associated with the resource consumption associated with the one of the respective user profiles is visually correlated to the at least one of the graphical or numerical representation of the indication of the resource consumption caused by the detected use of the component associated with the one of the respective user profiles.

5. The method of claim 1, wherein the period of time comprises a first period of time, and further comprising:
determining, by the mobile computing device, for each of the at least two respective user profiles and for the second period of time, resource consumption caused by the detected use of the component of the mobile computing device over a period of time; and
generating, by the mobile computing device, for the at least one of the at least two respective user profiles, a visual representation comprising an indication of the resource consumption caused by the detected use of the component associated with the one of the respective user profiles, an indication of the component associated with the resource consumption associated with the one of the respective user profiles, an indication of the one of the respective user profiles, and an indication of the second period of time.

6. The method of claim 1, wherein the visual representation comprises at least one of a pictorial or textual representation of the indication of the component associated with the resource consumption associated with the one of the respective user profiles and at least one of a pictorial, graphical, or a numerical representation of the indication of the resource consumption caused by the detected use of the component associated with one of the respective user profiles.

7. The method of claim 1, wherein the visual representation comprises a pictorial representation of the indication of the one of the respective user profiles.

8. The method of claim 1, wherein the one of the respective user profiles comprises a first respective user profile, further comprising:
generating, by the mobile computing device, for a second respective user profile of the at least two user profiles, a visual representation comprising an indication of the resource consumption caused by the detected use of the component associated with the second respective user profile, an indication of the component associated with the resource consumption associated with the second respective user profile, and an indication of the second respective user profile.

9. The method of claim 1, generating, by the mobile computing device, the visual representation comprises identifying, by the mobile computing device, the one of the respective user profiles as an active user profile of the plurality of user profiles when the use of the component occurred.

10. A mobile computing device configured to operate, at a given time, based at least in part on one or more configuration settings associated with one user profile of a plurality of user profiles, comprising:
a component comprising at least one of a hardware or a software component or the mobile device;
a display device; and
at least one processor, wherein the at least one processor is configured to:
detect, for at least two respective user profiles of the plurality of user profiles, use of the component associated with the respective user profile,
determine, for each of the at least two respective user profiles, resource consumption caused by the detected use of the component over a period of time, wherein the resource consumption comprises at least one of an amount of data transmissions and power consumption of a battery of the mobile computing device,
generate, for at least one of the at least two respective user profiles, a visual representation comprising an indication of the resource consumption caused by the detected use of the component associated with one of the respective user profiles, an indication of the component associated with the resource consumption associated with the one of the respective user profiles, and an indication of the one of the respective user profiles, and
cause the visual representation to be displayed at the display device.

11. The mobile computing device of claim 10, wherein the visual representation comprises a pictorial representation the indication of the component associated with the resource consumption associated with the one of the respective user profiles, at least one of a graphical or numerical representation of the indication of the resource consumption caused by the detected use of the component associated with the one of the respective user profiles, a pictorial representation of the indication of the one of the respective user profiles, and a numerical representation of the period of time.

12. The mobile computing device of claim 11, wherein the pictorial representation of the indication of the component associated with the resource consumption associated with the one of the respective user profiles is visually correlated to the at least one of the graphical or numerical representation of the indication of the resource consumption caused by the detected use of the component associated with the one of the respective user profiles.

13. The mobile computing device of claim 10, wherein the period of time comprises a first period of time, and wherein the at least one processor is further configured to:
determine, for each of the at least two respective user profiles and for the second period of time, resource consumption caused by the detected use of the component of the mobile computing device over a second period of time; and
generating, by the mobile computing device, for the at least one of the at least two respective user profiles, a visual representation comprising an indication of the resource consumption caused by the detected use of the component associated with the one of the respective user profiles, an indication of the component associated with the resource consumption associated with the one of the respective user profiles, an indication of the one of the respective user profiles, and an indication of the second period of time.

14. The mobile computing device of claim 10, wherein the one of the respective user profiles comprises a first respective user profile, further comprising:
generating, by the mobile computing device, for a second respective user profile of the at least two user profiles, a visual representation comprising an indication of the resource consumption caused by the detected use of the component associated with the second respective user profile, an indication of the component associated with the resource consumption associated with the second respective user profile, and an indication of the second respective user profile.

15. The mobile computing device of claim 10, wherein the processor is further configured to identify the one of the respective user profiles as an active user profile of the plurality of user profiles when the use of the component occurred.

16. A computer-readable storage medium encoded with instructions that, when executed, cause at least one processor of a mobile computing device to:
detect, for at least two respective user profiles of a plurality of user profiles, use of a component of the mobile computing device associated with the respective user profile, wherein the component comprises at least one of a hardware or a software component of the mobile device, and wherein the mobile computing device is configured to operate, at a given time, based at least in part on one or more configuration settings associated with one user profile of the plurality of user profiles;
determine, for each of the at least two respective user profiles, resource consumption caused by the detected use of the component of the mobile computing device over a period of time, wherein the resource consumption comprises at least one of an amount of data transmissions and power consumption of a battery of the mobile computing device; and
generate, for at least one of the at least two respective user profiles, a visual representation comprising at least one of a pictorial, graphical, or a numerical representation of an indication of the resource consumption caused by the detected use of the component associated with one of the respective user profiles, at least one of a pictorial or textual representation of an indication of the component associated with the resource consumption associated with the one of the respective user profiles, an indication of the one of the respective user profiles, and an indication of the period of time.

17. The computer-readable storage medium of claim 16, wherein the visual representation comprises the pictorial representation the indication of the component associated with the resource consumption associated with the one of the respective user profiles, at least one of the graphical or the numerical representation of the indication of the resource consumption caused by the detected use of the component associated with the one of the respective user profiles, a pictorial representation of the indication of the one of the respective user profiles, and a numerical representation of the period of time.

18. The computer-readable storage medium of claim 17, wherein the pictorial representation of the indication of the component associated with the resource consumption associated with the one of the respective user profiles is visually correlated to the at least one of the graphical or the numerical representation of the indication of the resource consumption caused by the detected use of the component associated with the one of the respective user profiles.

19. The computer-readable storage medium of claim 16, wherein the period of time comprises a first period of time, and further comprising instruction that, when executed, cause at least one processor of a mobile computing device to:
determine, for each of the at least two respective user profiles and for the second period of time, resource consumption caused by the detected use of the component of the mobile computing device over a second period of time; and
generate, for the at least one of the at least two respective user profiles, a visual representation comprising an indication of the resource consumption caused by the detected use of the component associated with the one of the respective user profiles, an indication of the component associated with the resource consumption associated with the one of the respective user profiles, an indication of the one of the respective user profiles, and an indication of the second period of time.

20. The computer-readable storage medium of claim 16, wherein the one of the respective user profiles comprises a first respective user profile, further comprising:
generating, by the mobile computing device, for a second respective user profile of the at least two user profiles, a visual representation comprising an indication of the resource consumption caused by the detected use of the component associated with the second respective user profile, an indication of the component associated with the resource consumption associated with the second respective user profile, and an indication of the second respective user profile.
